(19) United States
(12) Patent Application Publication
(10) Pub. No.: US 2023/0082111 A1
(43) Pub. Date: Mar. 16, 2023

(54) HIGH PRESSURE FUEL PUMP

(71) Applicant: DENSO CORPORATION, Kariya-city (JP)

(72) Inventor: Hiroshi INOUE, Kariya-city (JP)

(21) Appl. No.: 17/988,149

(22) Filed: Nov. 16, 2022

Related U.S. Application Data
(63) Continuation of application No. PCT/JP2021/029264, filed on Aug. 6, 2021.

(30) Foreign Application Priority Data
Aug. 20, 2020 (JP) 2020-139355

(51) Int. Cl. F16J 9/10; F04B 53/14; F04B 53/16

(52) U.S. Cl. CPC F16J 9/10; F04B 53/14; F04B 53/16

(57) ABSTRACT

A seal ring is in contact with an outer peripheral surface of a plunger. A biasing ring is made of a material having a lower fuel resistance than the seal ring, and is provided radially outwardly with respect to the seal ring in a seal chamber so as to bias the seal ring against the plunger. An axial position of a portion of the seal ring where a surface pressure on the plunger is maximum is defined as a maximum surface pressure position. The seal ring has diameter changing portions in both axial directions with respect to the maximum surface pressure position. The diameter changing portions are formed so as to have an outer diameter smaller than that of the portion corresponding to the maximum surface pressure position.

### CROSS REFERENCE TO RELATED APPLICATIONS

This application is a continuation application of International Patent Application No. PCT/JP2021/029264 filed on Aug. 6, 2021, which designated the U.S. and based on and claims the benefits of priority of Japanese Patent Application No. 2020-139355 filed on Aug. 20, 2020. The entire disclosure of all of the above applications is incorporated herein by reference.

### TECHNICAL FIELD

The present invention relates to a high pressure fuel pump.

### BACKGROUND

Conventionally, in a high pressure fuel pump, a seal ring suppresses leakage of fuel along an outer peripheral side of a plunger.

### SUMMARY

A high pressure fuel pump suppresses compression cracking of the biasing ring.

A high pressure fuel pump of the present disclosure includes a cylinder having a pressure chamber, a plunger that changes a volume of the pressure chamber by axially reciprocating with respect to the cylinder, a seal chamber forming portion that separates the seal chamber between the plunger outside of the cylinder, and a seal ring and a biasing ring provided within the seal chamber. The seal ring is in contact with an outer peripheral surface of the plunger. The biasing ring is made of a material having lower fuel resistance than the seal ring, and is provided radially outwardly with respect to the seal ring in the seal chamber so as to bias the seal ring against the plunger.

### BRIEF DESCRIPTION OF DRAWINGS

The above and other objects, features and advantages of the present disclosure will become more apparent from the following detailed description taken in conjunction with the accompanying drawings.

In the drawings:

FIG. 1 is a schematic cross-sectional view showing a high pressure fuel pump of a first embodiment;

FIG. 2 is a cross-sectional view showing an enlarged part II of FIG. 1;

FIG. 3 is a cross-sectional view of a fuel seal of FIG. 2 showing a biasing ring in an uncompressed state;

FIG. 4 is a surface pressure distribution diagram of the seal ring of FIG. 2 on the plunger;

FIG. 5 is a cross-sectional view of a fuel seal of a second embodiment;

FIG. 6 is a view showing the biasing ring in an uncompressed state with respect to the fuel seal of FIG. 5;

FIG. 7 is a surface pressure distribution diagram of the seal ring of FIG. 5 on the plunger;

FIG. 8 is a cross-sectional view of a fuel seal of a third embodiment;

FIG. 9 is a view showing the biasing ring in an uncompressed state with respect to the fuel seal of FIG. 8;

FIG. 10 is a surface pressure distribution diagram of the seal ring of FIG. 8 on the plunger;

FIG. 11 is a cross-sectional view of a fuel seal of a fourth embodiment;

FIG. 12 is a surface pressure distribution diagram of the seal ring of FIG. 11 on the plunger;

FIG. 13 is a cross-sectional view of a fuel seal of a fifth embodiment;

FIG. 14 is a surface pressure distribution diagram of the seal ring of FIG. 13 on the plunger;

FIG. 15 is a cross-sectional view of a fuel seal of a sixth embodiment;

FIG. 16 is a view showing the biasing ring in an uncompressed state with respect to the fuel seal of FIG. 15;

FIG. 17 is a surface pressure distribution diagram of the seal ring of FIG. 15 on the plunger;

FIG. 18 is a cross-sectional view of a fuel seal of a seventh embodiment;

FIG. 19 is a view showing the biasing ring in an uncompressed state with respect to the fuel seal of FIG. 18;

FIG. 20 is a surface pressure distribution diagram of the seal ring of FIG. 18 on the plunger;

FIG. 21 is a cross-sectional view of a fuel seal of a comparative embodiment; and

FIG. 22 is a view showing the biasing ring in an uncompressed state with respect to the fuel seal of FIG. 21.

### DETAILED DESCRIPTION

In an assumable example, in a high pressure fuel pump, a seal ring suppresses leakage of fuel along an outer peripheral side of a plunger. A fuel seal is configured by combining a seal ring having a rectangular cross section and an O-ring having a circular cross section provided radially outwardly of the seal ring as a biasing ring.

A thickness of the O-ring and its maximum compression amount affect a leak amount of fuel as a maximum surface pressure of a sliding portion of the seal ring on the plunger. Therefore, the thickness of the O-ring and a radial thickness of the seal ring are determined by a limit value of the leak amount of fuel. Due to restrictions imposed by the size of the high pressure fuel pump, there is a limit to the installation space of the fuel seal. Therefore, an O-ring made of a material having lower fuel resistance than the seal ring may swell excessively to exceed the maximum compressibility, which may cause compression cracking. In particular, in areas where fuel properties are not good, when ethanol-containing fuel or additive-containing fuel is used, for example, compression cracking becomes conspicuous.

A high pressure fuel pump suppresses compression cracking of the biasing ring.

A high pressure fuel pump of the present disclosure includes a cylinder having a pressure chamber, a plunger that changes a volume of the pressure chamber by axially reciprocating with respect to the cylinder, a seal chamber forming portion that separates the seal chamber between the plunger outside of the cylinder, and a seal ring and a biasing ring provided within the seal chamber. The seal ring is in contact with an outer peripheral surface of the plunger. The biasing ring is made of a material having lower fuel resistance than the seal ring, and is provided radially outwardly with respect to the seal ring in the seal chamber so as to bias the seal ring against the plunger.

Here, an axial position of “a portion of the seal ring where the surface pressure on the plunger is maximum” is defined as a maximum surface pressure position. A cross section passing through a central axis of the plunger is defined as a longitudinal section. A circle circumscribing one side of the biasing ring in an uncompressed state appearing in the longitudinal section is defined as a virtual circumscribing circle. A solid formed by rotating the virtual circumscribing circle around the central axis is defined as a virtual standard ring.

In a first aspect of the present disclosure, the seal ring has diameter changing portions in both axial directions with respect to the maximum surface pressure position. The diameter changing portions are formed so as to have an outer diameter smaller than that of the portion corresponding to “the maximum surface pressure position”.

In a second aspect of the present disclosure, the biasing ring in an uncompressed state has a diameter changing portion formed on one side or on both ends in an axial direction with respect to the maximum surface pressure position, and to have an outer diameter smaller than that of the virtual standard ring, or to have an inner diameter larger than that of the virtual standard ring.

As a result, even if an installation space of the fuel seal (that is, the volume of the seal chamber) is the same as in a comparative embodiment, an allowable swelling space of the biasing ring is increased by the smaller outer diameter of the diameter changing portion, or the larger outer diameter of the diameter changing portion. Therefore, the allowable swelling limit of the biasing ring is increased, and compression cracking due to swelling of the biasing ring can be suppressed even when ethanol-containing fuel or additive-containing fuel is used.

Furthermore, since a surface pressure distribution of the seal ring to the plunger is improved in this way, the sliding resistance between the seal ring and the plunger can be reduced, and the slidability between them is improved.

Hereinafter, a plurality of embodiments of a high pressure fuel pump will be described with reference to the drawings. In the embodiments, components which are substantially similar to each other are denoted by the same reference numerals and redundant description thereof is omitted.

### First Embodiment

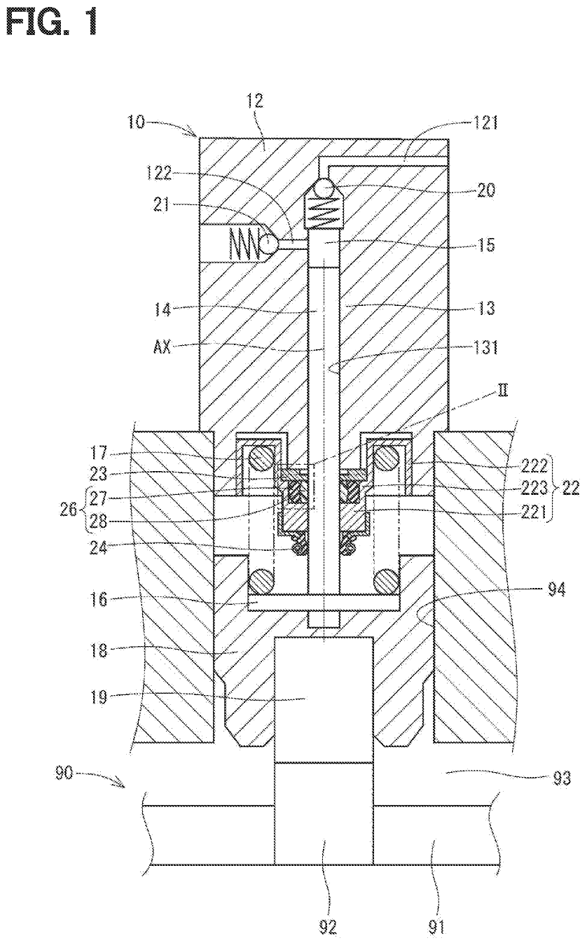

As shown in FIG. 1, a high pressure fuel pump 10 of the first embodiment is a device that pressurizes fuel sent from a fuel tank (not shown) and discharges it to a fuel rail (not shown), by using a rotational power of a cam 92 of a cam shaft 91 of an engine 90.

A housing 12 is inserted into a through hole 94 of the engine 90 so as to block an upper end side of the through hole 94. A space within a cam chamber 93 and the through hole 94 is filled with oil for lubrication.

A cylinder 13 is formed integrally with the housing 12 forming an outer shell of the high pressure fuel pump 10. In other embodiments, the cylinder may be formed separately from the housing and the fuel passage forming member. The cylinder 13 is formed with a cylindrical plunger insertion hole 131. A cylindrical plunger 14 is slidably inserted into the plunger insertion hole 131. A pressure chamber 15 is defined by an upper end surface of the plunger 14 and an inner peripheral surface of the cylinder 13.

A seat 16 is connected to a lower end of the plunger 14. The seat 16 is pressed against a tappet 18 by a spring 17. The tappet 18 is slidably inserted into the through hole 94. A roller 19 is rotatably attached to the tappet 18. The roller 19 is in contact with the cam 92.

When the cam 92 is rotated by the rotation of the cam shaft 91, the plunger 14 is axially reciprocated together with the seat 16, the tappet 18, and the roller 19. The plunger 14 changes a volume of the pressure chamber 15 by axially reciprocating with respect to the cylinder 13.

The housing 12 is formed with an intake passage 121 that guides fuel to the pressure chamber 15 and a discharge passage 122 that discharges the fuel in the pressure chamber 15 to the outside. A suction valve 20 that opens during a suction stroke is arranged in the intake passage 121. A discharge valve 21 that opens during a discharge stroke is arranged in the discharge passage 122.

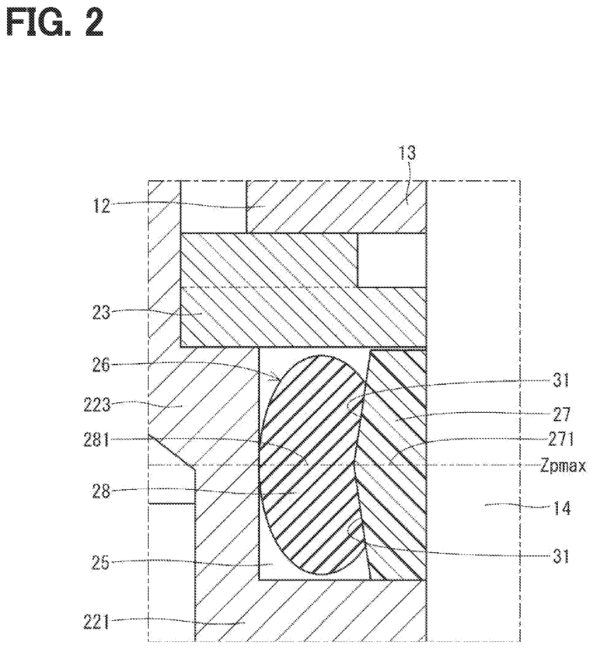

As shown in FIGS. 1 and 2, a seal holder 22 is attached to the end of the housing 12. The seal holder 22 has an annular fitting portion 221 fitted to the plunger 14, a cylindrical press-fitting portion 222 press-fitted into the housing 12, and a cylindrical connecting portion 223 extending from the fitting portion 221 to the press-fitting portion 222. A disk-shaped plunger stopper 23 is arranged between a stepped portion of the inner wall of the connecting portion 223 and the housing 12 in the axial direction.

An oil seal 24 is attached to the seat 16 side of the fitting portion 221. The oil seal 24 suppresses leakage of oil from the space in the through hole 94 to a seal chamber 25 described later.

The seal holder 22 defines the seal chamber 25 between itself and the plunger 14 outside the cylinder 13. Specifically, the seal chamber 25 is an annular space defined by an outer peripheral surface of the plunger 14, an inner wall surface of the connecting portion 223, an end surface of the fitting portion 221, and an end surface of the plunger stopper 23. A fuel seal 26 is arranged in the seal chamber 25. The fuel seal 26 adjusts a thickness of the fuel oil film around the plunger 14, and suppresses leakage of fuel from the pressure chamber 15 through the outer periphery of the plunger 14 to the space inside the through hole 94.

The fuel seal 26 is composed of a seal ring 27 and a biasing ring 28 provided in the seal chamber 25. The seal ring 27 is made of resin such as polytetrafluoroethylene (PTFE), and is in contact with the outer peripheral surface of the plunger 14. The biasing ring 28 is made of an elastic material such as rubber, which has lower fuel resistance than the seal ring 27, and is provided outside the seal ring 27 in the seal chamber 25 in the radial direction. The biasing ring 28 is radially compressed between the connecting portion 223 and the seal ring 27 to bias the seal ring 27 against the plunger 14.

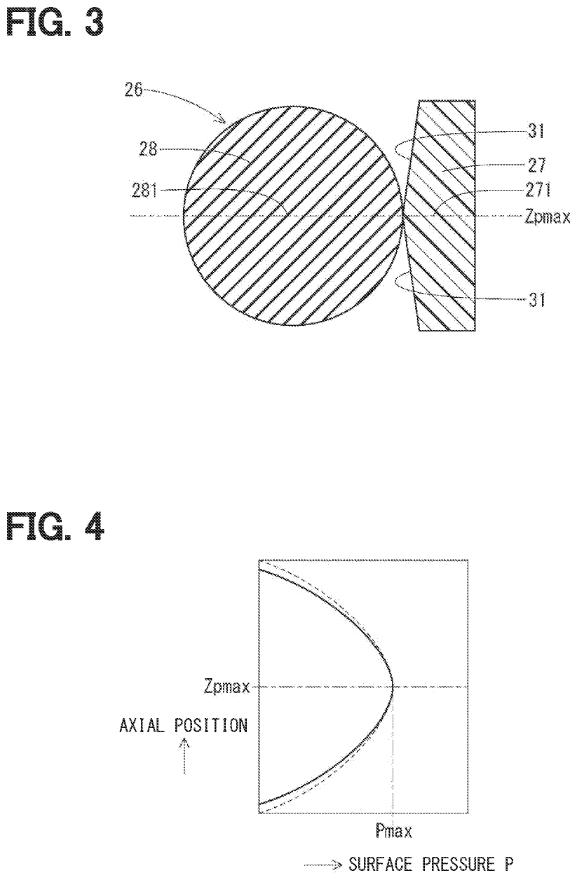

Next, the fuel seal 26 will be described in detail. A cross section passing through a central axis AX of the plunger 14 is defined as a longitudinal section. A direction parallel to the central axis AX is defined as an axial direction. As shown in FIG. 3, the biasing ring 28 is an O-ring having a circular vertical cross-sectional shape in an uncompressed state. The biasing ring 28 has a maximum radial thickness at a center in the axial direction. A portion of the biasing ring 28 having the maximum radial thickness is defined as a biasing side maximum thickness portion 281. In other embodiments, the biasing side maximum thickness portion may be offset from the axial center of the biasing ring. Further, the biasing ring may be formed so that one axial direction and the other axial direction with respect to the biasing side maximum thickness portion are asymmetrical.

The seal ring 27 is generally formed in a cylindrical shape. An inner sliding surface of the seal ring 27 is a cylindrical surface. The seal ring 27 has the maximum radial thickness at an axial position corresponding to the biasing side maximum thickness portion at the axial center. A portion of the seal ring 27 having the maximum radial thickness is defined as a seal side maximum thickness portion 271. In other embodiments, the seal side maximum thickness portion may be offset from the axial center of the seal ring. Further, the seal ring may be formed so that one axial direction and the other axial direction with respect to the seal side maximum thickness portion are asymmetrical.

As shown in FIG. 4, a surface pressure P of the seal ring 27 on the plunger 14 reaches a maximum surface pressure Pmax at an axial position corresponding to the biasing side maximum thickness portion 281. The axial position corresponding to the maximum surface pressure Pmax, that is, the axial position of “the portion of the seal ring 27 where the surface pressure P on the plunger 14 is maximum” is defined as the maximum surface pressure position Zpmax. The surface pressure P decreases as it moves away from the maximum surface pressure position Zpmax in the axial direction.

As shown in FIGS. 2 and 3, the seal ring 27 has the maximum radial thickness at the maximum surface pressure position Zpmax. In addition, the seal ring 27 has diameter changing portions 31 in both axial directions with respect to the maximum contact pressure position Zpmax. The diameter changing portions 31 are formed so as to have an outer diameter smaller than that of the seal side maximum thickness portion 271 as “a portion corresponding to the maximum surface pressure position Zpmax”. In the first embodiment, the diameter changing portion 31 is a tapered surface whose outer diameter decreases with distance from the seal side maximum thickness portion 271.

In the first embodiment, the seal side maximum thickness portion 271 is formed only at the maximum surface pressure position Zpmax, and the diameter changing portions 31 are formed adjacent to the maximum surface pressure position Zpmax. On the other hand, in another embodiment, the seal side maximum thickness portion may be formed over a certain range in the axial direction including the maximum surface pressure position Zpmax, and the diameter changing portions may be formed away from the maximum surface pressure position Zpmax. Also, the diameter changing portions may be composed of a plurality of tapered surfaces. Further, the corners of the boundary between the seal side maximum thickness portion and the diameter changing portion may be formed so as to be rounded.

(Effects)

Advantageous effects of the first embodiment will be described below in comparison with the conventional embodiment. As shown in FIGS. 21 and 22, a fuel seal 81 in a comparative embodiment is composed of a biasing ring 82 similar to the biasing ring 28 of the first embodiment, and a seal ring 83. The seal ring 83 is formed in a cylindrical shape so as to have the same radial thickness as the seal side maximum thickness portion 271 of the first embodiment in the entire axial direction. That is, an outer peripheral surface of the seal ring 83 is a cylindrical surface.

In the first embodiment, the seal ring 27 has diameter changing portions 31 in both axial directions with respect to the maximum contact pressure position Zpmax. The diameter changing portions 31 are formed so as to have an outer diameter smaller than that of the portion corresponding to “the maximum surface pressure position Zpmax”. In the comparative embodiment, such diameter changing portion 31 is not formed.

As a result, even if an installation space of the fuel seal 26 (that is, the volume of the seal chamber 25) is the same as in the comparative embodiment, an allowable swelling space of the biasing ring 28 is increased by the smaller outer diameter of the diameter changing portions 31. Comparing the seal ring 27 and the seal ring 83 in the comparative embodiment, an allowable space for swelling of the biasing ring 28 is created outside the diameter change portions 31 of the seal ring 27. Therefore, the allowable swelling limit of the biasing ring 28 is increased, and compression cracking due to swelling of the biasing ring 28 can be suppressed even when ethanol-containing fuel or additive-containing fuel is used.

Further, in the seal ring 27, there is no portion protruding radially outward beyond the seal side maximum thickness portion 271 in both axial directions with respect to the maximum surface pressure position Zpmax. Therefore, the allowable swelling limit of the biasing ring 28 is increased.

Further, as shown in FIG. 4, when the maximum surface pressure Pmax is the same between the first embodiment and the comparative embodiment, the contact pressure in the first embodiment indicated by a solid line is smaller at the axial position corresponding to the diameter changing portions 31 than the contact pressure in the comparative embodiment indicated by the dashed line. Since a surface pressure distribution of the seal ring 27 to the plunger 14 is improved in this way, the sliding resistance between the seal ring 27 and the plunger 14 can be reduced, and the slidability between them is improved.

Further, in the first embodiment, the diameter changing portions 31 are tapered surfaces. As a result, the allowable swelling space of the biasing ring 28 can be increased and the surface pressure distribution of the seal ring 27 can be improved with a relatively simple shape.

### Second Embodiment

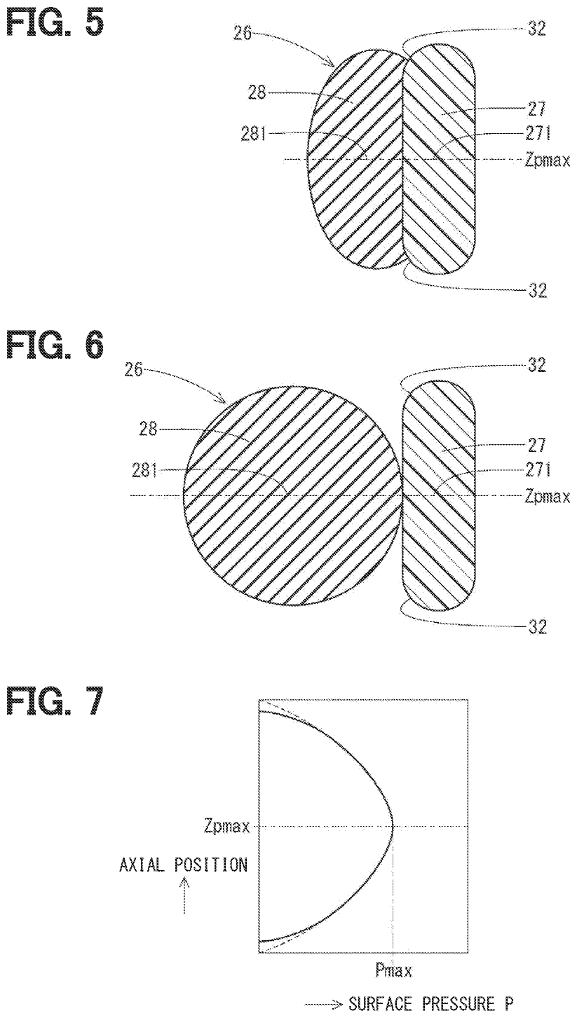

As shown in FIGS. 5 and 6, in a second embodiment, the radially outer and radially inner corners of the seal ring 27 are rounded. The radial thickness of the seal ring 27 is maximum at the center in the axial direction and decreases at both ends in the axial direction as the distance from the center in the axial direction increases.

The diameter changing portion 32 is a convex curved surface whose outer diameter decreases with increasing distance from the seal side maximum thickness portion 271. As a result, the allowable swelling space of the biasing ring 28 is increased due to the smaller outer diameter of the diameter changing portion 32, and the surface pressure distribution of the seal ring 27 can be improved as shown in FIG. 7. Therefore, according to the second embodiment, effects similar to those of the first embodiment can be obtained.

In the second embodiment, the seal side maximum thickness portion 271 is formed over a certain range in the axial direction including the maximum surface pressure position Zpmax, and the diameter changing portions are formed away from the maximum surface pressure position Zpmax. On the other hand, in another embodiment, the seal side maximum thickness portion may be formed only at the maximum surface pressure position Zpmax, and the diameter changing portions may be formed adjacent to the maximum surface pressure position Zpmax. Also, the radius of curvature of the convex curved surface that is the diameter changing portion may not be constant.

### Third Embodiment

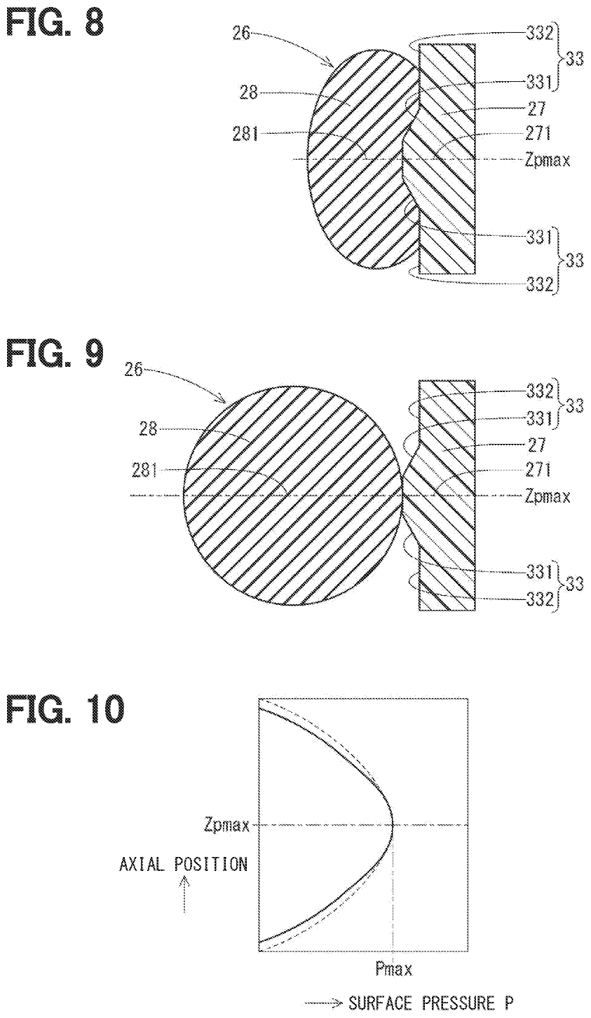

As shown in FIGS. 8 and 9, in a third embodiment, the seal ring 27 is formed such that both end portions in the axial direction are recessed radially inward compared to the center portion in the axial direction. The radial thickness of the seal ring 27 is maximum at the axial center portion, and is smaller at both axial end portions than at the axial center portion.

The diameter changing portion 33 is a concave surface having inclined surfaces 331 and small-diameter cylindrical surfaces 332. The concave surface means that it is recessed radially inward from the seal side maximum thickness portion 271. The outer diameter of the inclined surfaces 331 decreases with increasing distance from the seal side maximum thickness portion 271. The small-diameter cylindrical surface 332 is formed on the side opposite to the seal side maximum thickness portion 271 with respect to the inclined surfaces 331 in the axial direction. As a result, the allowable swelling space of the biasing ring 28 is increased due to the smaller outer diameter of the diameter changing portion 33, and the surface pressure distribution of the seal ring 27 can be improved as shown in FIG. 10. Therefore, according to the third embodiment, effects similar to those of the first embodiment can be obtained.

In the second embodiment, the seal side maximum thickness portion 271 is formed over a certain range in the axial direction including the maximum surface pressure position Zpmax, and the diameter changing portions are formed away from the maximum surface pressure position Zpmax. On the other hand, in another embodiment, the seal side maximum thickness portion may be formed only at the maximum surface pressure position Zpmax, and the diameter changing portions may be formed adjacent to the maximum surface pressure position Zpmax. Further, the concave surface that is the diameter changing portion is not limited to a combination of a tapered surface and a cylindrical surface, and may have a concave curved surface in addition to them, or may be composed only of a concave curved surface.

### Fourth Embodiment

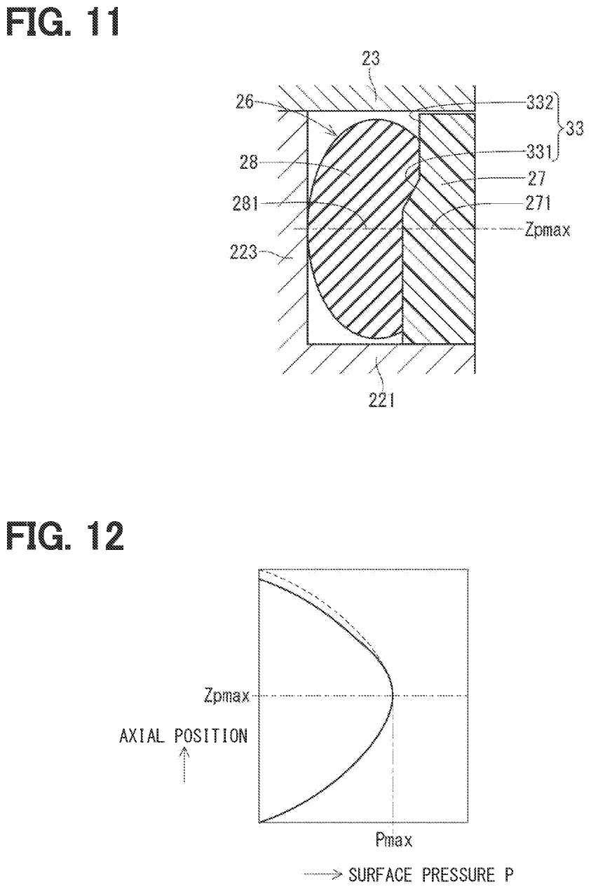

As shown in FIG. 11, in a fourth embodiment, a diameter changing portion 33 similar to that in the third embodiment is formed only on one side in the axial direction (that is, on the plunger stopper 23 side). Even if the diameter changing portion 33 is formed only on one side in the axial direction, the allowable swelling space of the biasing ring 28 is increased by the smaller outer diameter of the diameter changing portion 33, and the surface pressure distribution of the seal ring 27 can be improved as shown in FIG. 12.

In the fourth embodiment, the same diameter changing portion 33 as in the third embodiment is formed only on one side in the axial direction. On the other hand, in another embodiment, the diameter changing portion 31 of the first embodiment or the diameter changing portion 32 of the second embodiment may be formed only on one side in the axial direction. Accordingly, the same effects as in the fourth embodiment can be obtained.

### Fifth Embodiment

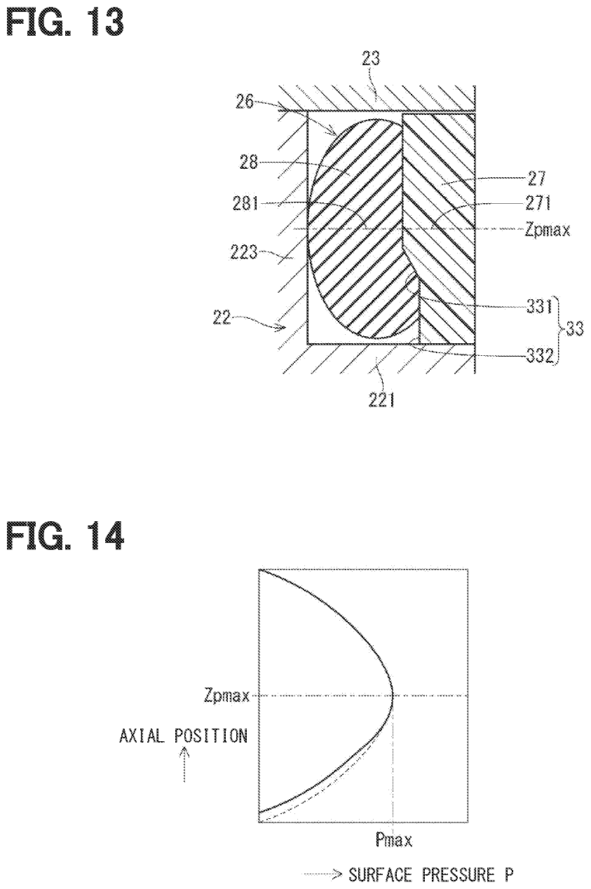

As shown in FIG. 13, in a fifth embodiment, a diameter changing portion 33 similar to that in the third embodiment is formed only on the other side in the axial direction (that is, on the fitting portion 221 side). Even if the diameter changing portion 33 is formed only on the other side in the axial direction, the allowable swelling space of the biasing ring 28 is increased by the smaller outer diameter of the diameter changing portion 33, and the surface pressure distribution of the seal ring 27 can be improved as shown in FIG. 14.

Further, since the diameter changing portion 33 is provided only in the “assembly direction of the biasing ring 28 to the seal holder 22” with respect to the maximum surface pressure position Zpmax, the biasing ring 28 can be mounted while the seal ring 27 is pressing the biasing ring 28 during assembly. Therefore, the mountability of the biasing ring 28 to the seal holder 22 is excellent.

In the fifth embodiment, the same diameter changing portion 33 as in the third embodiment is formed only on the other side in the axial direction. On the other hand, in another embodiment, the diameter changing portion 31 of the first embodiment or the diameter changing portion 32 of the second embodiment may be formed only on the other side in the axial direction. Accordingly, the same effects as in the fifth embodiment can be obtained.

### Sixth Embodiment

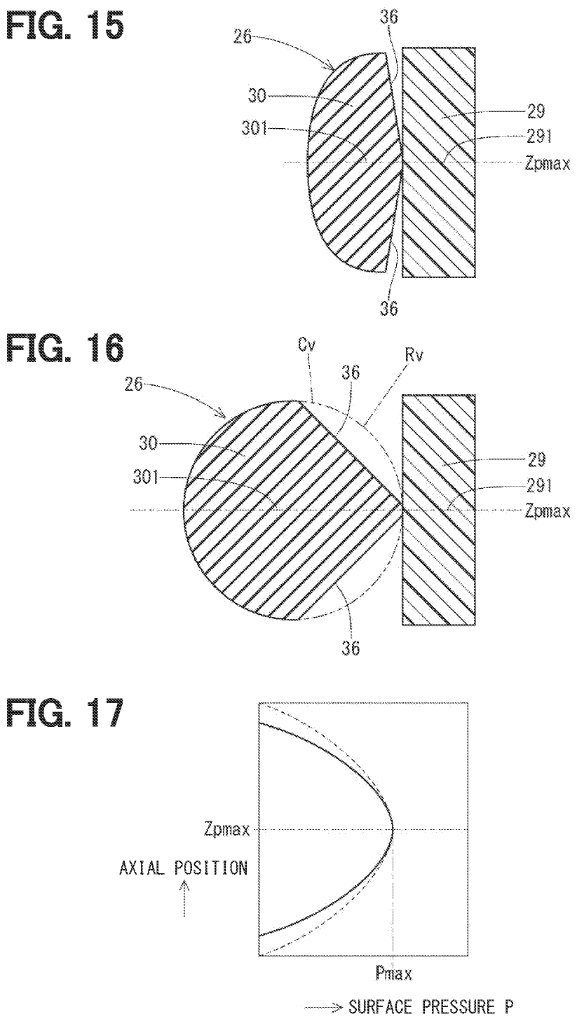

As shown in FIGS. 15 and 16, in the sixth embodiment, the seal ring 29 is formed in a cylindrical shape so as to have the same radial thickness as the seal side maximum thickness portion 291 throughout the axial direction, similarly to the seal ring 83 in the comparative embodiment. The diameter changing portion 36 is formed radially inside the biasing ring 30 instead of the seal ring 29.

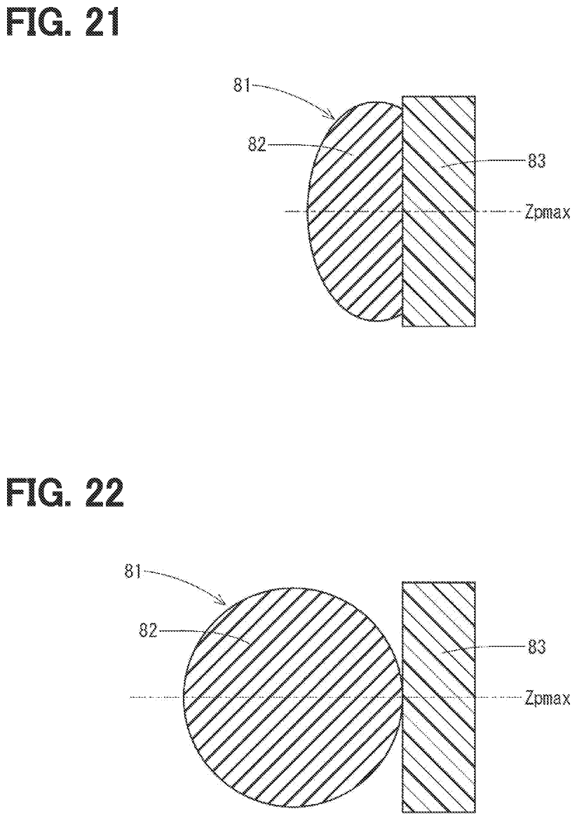

Here, as shown in FIG. 16, a circle circumscribing “one side of the biasing ring 30 in the uncompressed state” appearing in the longitudinal section is defined as a virtual circumscribing circle Cv. A solid formed by rotating the virtual circumscribing circle Cv around the central axis AX (see FIG. 1) is defined as a virtual standard ring Rv. The diameter changing portion 36 is formed to have an inner diameter larger than that of the virtual standard ring Rv in both axial directions with respect to the maximum surface pressure position Zpmax when the biasing ring 30 is in a non-compressed state. As a result, the allowable swelling space of the biasing ring 30 is increased by the larger inner diameter of the diameter changing portion 36, and the surface pressure distribution of the seal ring 29 can be improved as shown in FIG. 17. Comparing the biasing ring 30 and the biasing ring 82 (see FIGS. 20 and 21) in the comparative embodiment, an allowable space for swelling of the biasing ring 30 is created inside the diameter changing portion 36 of the biasing ring 30. Furthermore, since the diameter changing portion 36 can be molded with a mold, it can be manufactured at low cost.

In the sixth embodiment, the diameter changing portion 36 is a tapered surface whose inner diameter increases with increasing distance from the biasing side maximum thickness portion 301. In contrast, in other embodiments, the diameter changing portion may consist of a convex curved surface or a concave surface.

### Seventh Embodiment

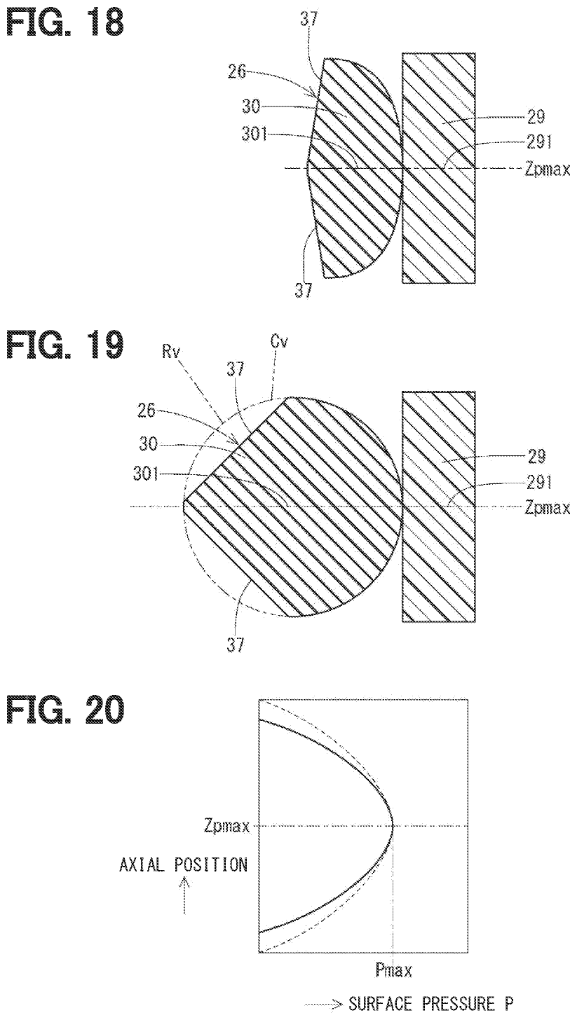

As shown in FIGS. 18 and 19, in the seventh embodiment, the diameter changing portion 37 is formed radially outward of the biasing ring 30. That is, the diameter changing portion 37 is formed to have an outer diameter smaller than that of the virtual standard ring Rv in both axial directions with respect to the maximum surface pressure position Zpmax when the biasing ring 30 is in a non-compressed state. As a result, the allowable swelling space of the biasing ring 30 is increased due to the smaller outer diameter of the diameter changing portion 37, and the surface pressure distribution of the seal ring 29 can be improved as shown in FIG. 20. Furthermore, since the diameter changing portion 37 can be molded with a mold, it can be manufactured at low cost. Furthermore, since the diameter changing portion 37 is formed radially outward of the biasing ring 30, the inner portion of the biasing ring 30 has the same shape as the comparative embodiment, and it is possible to secure a contact area between the biasing ring 30 and the seal ring 29. Therefore, an axial displacement between the biasing ring 30 and the seal ring 29 is suppressed.

In the seventh embodiment, the diameter changing portion 37 is a tapered surface whose outer diameter decreases with increasing distance from the biasing side maximum thickness portion 301. In contrast, in other embodiments, the diameter changing portion may consist of a convex curved surface or a concave surface.

The present disclosure is not limited to the embodiments described above, and various modifications are possible within the scope of the present disclosure without departing from the spirit of the invention.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A high pressure fuel pump, comprising:
a cylinder having a pressure chamber;
a plunger configured to change a volume of the pressure chamber by axially reciprocating with respect to the cylinder;
a seal chamber forming portion configured to define a seal chamber between itself and the plunger outside the cylinder;
a seal ring provided in the seal chamber and having a cylindrical surface in contact with an outer peripheral surface of the plunger; and
a biasing ring made of a material that have a lower fuel resistance than the seal ring and swells when immerse in fuel, and being provided radially outwardly with respect to the seal ring in the seal chamber so as to bias the seal ring against the plunger,
wherein
an axial position of the seal ring where a surface pressure on the plunger is maximum is defined as a maximum surface pressure position, and
a radially outer surface of the seal ring facing the biasing ring has a diameter changing portion formed on one side or on both ends in an axial direction with respect to the maximum surface pressure position and having an outer diameter smaller than that of a portion corresponding to the maximum surface pressure position.

2. The high pressure fuel pump according to claim 1, wherein
the seal ring has a maximum radial thickness at the maximum surface pressure position, and
the diameter changing portion is a tapered surface, a convex curved surface, or a concave surface.

3. The high pressure fuel pump according to claim 1, wherein
the diameter changing portion is provided in an assembly direction of the biasing ring to the seal chamber forming portion with respect to said maximum surface pressure position.

4. A high pressure fuel pump, comprising:
a cylinder having a pressure chamber;
a plunger configured to change a volume of the pressure chamber by axially reciprocating with respect to the cylinder;
a seal chamber forming portion configured to define a seal chamber between itself and the plunger outside the cylinder;
a seal ring provided in the seal chamber and in contact with an outer peripheral surface of the plunger; and
a biasing ring made of a material having a lower fuel resistance than the seal ring, and being provided radially outwardly with respect to the seal ring in the seal chamber so as to bias the seal ring against the plunger,
wherein
an axial position of the seal ring where a surface pressure on the plunger is maximum is defined as a maximum surface pressure position,
a cross section passing through a central axis of the plunger is defined as a longitudinal section,
a circle circumscribing one side of the biasing ring in an uncompressed state appearing in the longitudinal section is defined as a virtual circumscribing circle,
a solid formed by rotating the virtual circumscribing circle around the central axis is defined as a virtual standard ring, and
the biasing ring in an uncompressed state has a diameter changing portion formed on one side or on both ends in an axial direction with respect to the maximum surface pressure position and having an outer diameter smaller than that of the virtual standard ring, or having an inner diameter larger than that of the virtual standard ring.

5. The high pressure fuel pump according to claim 4, wherein
the biasing ring has a maximum radial thickness at the maximum surface pressure position, and
the diameter changing portion is a tapered surface, a convex curved surface, or a concave surface.

6. The high pressure fuel pump according to claim 4, wherein
the diameter changing portion is provided radially outward of the biasing ring.
